(19) United States
(12) Patent Application Publication
(10) Pub. No.: US 2026/0337792 A1
(43) Pub. Date: Oct. 29, 2026

(54) ELECTROLYSIS SYSTEM AND USE THEREOF

(71) Applicant: Siemens Energy Global GmbH & Co. KG, München (DE)

(72) Inventors: Sven Schumann, Wilhermsdorf (DE); Robert Fleck, Hemhofen (DE)

(21) Appl. No.: 19/118,420

(22) PCT Filed: Oct. 2, 2023
(86) PCT No.: PCT/EP2023/077221

§ 371 Date: Apr. 4, 2025

(30) Foreign Application Priority Data
Oct. 11, 2022 (DE) 10 2022 210 722.5

(51) Int. Cl. C25B 9/67; C25B 1/04; C25B 9/65; C25B 9/73; C25B 15/021

(52) U.S. Cl. CPC C25B 9/67; C25B 1/04; C25B 9/65; C25B 9/73; C25B 15/021

(57) ABSTRACT

The invention relates to an electrolysis system for generating hydrogen and oxygen as product gases, including an electrolysis module and a process unit, wherein the process unit has a reactant line for supplying process water and a product line, each of which is connected to the electrolysis module, and the process unit is equipped with a thermally insulating insulation device, including a thermal insulating material, such that a slow cooling of the process water is produced during a standstill operation.

### BACKGROUND

The invention relates to an electrolysis system for production of hydrogen and oxygen as product gases, comprising an electrolysis module and comprising a process technology unit. The invention further relates to the use of an electrolysis system.

An electrolysis system is a technical system that uses electrical current to bring about electrochemical conversion of matter in an electrolyzer, known as electrolysis. In accordance with the variety of different electrolyses, there are also a multitude of electrolyzers, for example an electrolyzer for water electrolysis, i.e. the breakdown of water as reactant to oxygen and hydrogen product gases.

There have for some time been increased considerations in the direction of using surplus energy from renewable sources during sunny and windy periods, i.e. periods with above-average solar or wind power generation, to produce products of value. One product of value may in particular be hydrogen which is produced using water electrolyzers. The hydrogen can be used, for example, to produce “EE gas”, synthesis gas produced using renewable energy.

In an electrolysis system, the electrolyzer generally include a multitude of electrolysis cells arranged and stacked adjacent to one another. The water electrolysis in the electrolysis cells breaks down water to hydrogen and oxygen. In the case of a PEM electrolyzer, distilled water as reactant is typically supplied on the anode side and split into hydrogen and oxygen at a proton-exchange membrane (PEM). The water is oxidized to oxygen at the anode. The protons pass through the proton-exchange membrane. Hydrogen is produced on the cathode side. The water is generally conveyed from a bottom side into the anode space and/or cathode space.

In addition to PEM electrolysis systems that work in an acidic environment, alkaline electrolyzers are also known and frequently used, for example. Also known are atmospheric electrolyzers that operate at an atmospheric or only low operating pressure, or else pressure electrolyzers that operate at a high operating pressure of 35 bar or higher.

In an electrolyzer, the individual electrolysis cells are typically stacked to form a module comprising a multitude of individual cells in an axial direction and are assembled to form the module or electrolysis module. An electrolyzer typically includes a multitude of modules, which collectively form what is called an electrolysis stack or simply “stack”. For example, 50 electrolysis cells may be stacked axially to form a module and in turn, for example, 5 modules may be stacked in axial direction to form a stack, and so such an electrolysis stack may comprise, for example, 250 cells in an axial overall composite.

As soon as, for example, the electrolysis modules or the electrolysis cells or the electrolysis stack have been filled with water for the first time in a PEM electrolyzer, for example after production, it has to be ensured that water (reactant water) or a water-gas mixture always remains in the modules during operation of the electrolyzer. Running-dry or drying-out has to be prevented in every phase of operation, since this would lead to irreversible damage to the electrolyzer. The membrane in particular must always be kept in a moist environment, but other functional parts and components such as the catalyst or the electrodes must not dry out either. This also applies to the risk of frost damage as a result of cold ambient temperatures below the freezing point of the electrolysis process water during a simultaneous prolonged plant shutdown. Freezing must therefore likewise be avoided.

In the case of an operating phase with planned and upcoming servicing or maintenance of the electrolyzer from a normal state of operation, for instance for service purposes, shutdown management of the electrolyzer is generally plannable in an efficient and forward-looking manner, and appropriate precautions and switch-off procedures can be initiated routinely and safely in order that water remains in the modules and can still additionally be circulated if necessary, in particular even after shutdown.

One source of renewable energies is wind power. Especially with offshore wind turbines close to the coast, it is possible to achieve high electrical outputs. A challenge, however, is that it is necessary to overcome a long distance from consumers, and there is no grid connection for supply of power to necessary auxiliary and protective systems for the electrolyzer in the event of a plant shutdown. Efforts to achieve an autonomous supply system for on-demand or precautionary protection of the electrolyzer of an electrolysis system have to date been found to be very costly and inconvenient when used offshore or in the case of a remote onshore connection. Especially in offshore electrolysis systems, very special attention has to be paid to the prevention of damage to the electrolyzer, since there is generally no grid connection available for supply. The prior art for this purpose therefore includes very complex backup systems consisting of batteries and emergency power supply devices which at least temporarily enable shutdown operation for protection of the electrolyzer during a shutdown of the production plant for example in the event of a period of low wind and insolation.

### SUMMARY

It is therefore an object of the invention to specify an electrolysis system in which shutdown operation is achievable in a technically simple and safe manner, such that efficient freezing protection is achievable even over a relatively long period of time. A further object is to specify an appropriate use of an electrolysis system in shutdown operation, in which protection against frost damage is achieved even in the event of an acute risk of frost.

The object directed to an electrolysis system is achieved in accordance with the invention by an electrolysis system for production of hydrogen and oxygen as product gases, including an electrolysis module and comprising a process technology unit, wherein the process technology unit has a reactant conduit for process water supply and a product conduit that are each connected to the electrolysis module, wherein the process technology unit is equipped with a thermally insulating insulation device including a thermal insulation material so as to accomplish slowed cooling of the process water in shutdown operation.

The invention proceeds here from the finding that, particularly in the event of interruption of the power supply for electrolysis, reliable and efficient shutdown operation or shutdown management with avoidance of system damage is required so as to absolutely avoid damage to the electrolysis modules and the electrolysis cells. If a grid connection of the electrolysis system to the public power grid is unavailable or fails for a prolonged period of time, it is urgently necessary to protect electrolysis modules and in particular the electrolysis cells from various risks which can result in destruction or total loss of sensitive components of the cell, such as the membrane of a PEM cell or electrode or catalyst material. In addition to cells running dry due to loss of water or a reduction in the level in the cells, freezing of the process water in electrolysis modules in particular has to be avoided.

This acute risk of total cell loss due to freezing has to be addressed, particularly at electrolysis system sites in areas with a risk of frost. This is of major importance particularly when the electrolysis system is set up offshore, since it is not possible here to connect to the public power grid for power supply even in shutdown operation. But this is also true in the case of onshore use in an isolated network operation without a public grid connection, for example in remote and less developed regions.

In any case, it is necessary that the sensitive electrolysis cells and their components are kept moist, i.e. that they are soaked with liquid water or flushed with water even in shutdown operation when power supply with electrolysis current is interrupted.

Considerable problems can be caused specifically by unforeseen and in particular safety-related or weather-related shutdowns and interruptions of the power supply, for example when the electrolysis system is directly connected to a wind turbine over a short period of time, or even instantaneous emergency shutdowns in the event of faults. Periods of low wind and insolation are therefore manageable on the producer side only with difficulty and with a high degree of technical complexity, particularly with regard to the prevention of frost damage at outside temperatures in the frost range, such that the water in the electrolysis cells freezes. In these applications, complex and costly battery systems, energy storage systems or emergency power generators have to be kept ready in the electrolysis system and have to be of very large size in order to secure electrical energy for minimum supply and keeping of the temperature of the process water in the electrolysis module above freezing point in the event of a power failure. In the event of power outages or periods of low wind and insolation in offshore use of much more than a few hours or even several days, freezing protection at low ambient temperatures below the freezing point of the water is then not assured. Freezing damage would be recorded within a short period of time.

The electrolysis system of the invention provides an effective remedy here by making the available operational heat energy of the process water utilizable in a simple manner in order to prevent the process water from freezing over a prolonged period of time. This makes use of the known auxiliary power systems, for instance battery storage devices for an electric heater, only to a minor degree, if at all. The process water in the process technology unit has a very high heat energy content owing to the high heat capacity of the water at an operating temperature level of about 60 ° C. Natural cooling would lead to cooling from 60 ° C. to 40 ° C. even within one hour after plant shutdown.

By means of the process technology unit equipped with the thermally insulating insulation device, this heat energy available in the electrolysis system is advantageously still utilizable in that it is kept in the process water circuit for as long as possible and the process water is not left to undergo rapid natural cooling. The thermal insulation material of the insulation device provides a passive insulation measure in order to keep the heat in the system for as long as possible. This means that, in shutdown operation, a slowed cooling of the process water can be brought about, and freezing damage in the electrolysis module is avoidable. The heat-carrying process water is available here at about 60 ° C. as heating medium via the reactant conduit as inlet conduit and the product conduit as return conduit. The thermal insulation of the process technology unit can thus considerably slow down the cooling process even under frost conditions. This provides a simple and efficient measure in order to advantageously maintain a low level of cost and inconvenience associated with the customary autonomous storage systems to date, such as batteries or emergency power systems for heating the process water, and to further reduce it compared to the known systems. Lower procurement and system costs owing to reduced material costs, weight, installation space requirement etc. should be noted, and the temperature control concept of the invention even enables shutdown of the electrolysis system for a prolonged period without any fear of harmful freezing damage to the cells.

This is particularly advantageous for isolated grid operation in the offshore environment of the electrolysis system. It is thus possible to reliably cope with several days of low wind and insolation or a power outage. A battery or other storage system may still be provided in the electrolysis system. However, this may have distinctly smaller dimensions because of intrinsic temperature maintenance by the thermal insulation device of the process technology unit, and is available as required specifically for other purposes, for instance for operating a circulation pump that is preferably present for the process water as heating medium in the reactant conduit or the product conduit. Maintenance of temperature can thus be enabled and maintained over several days by the circulation process, and cooling can be slowed, with reliable prevention of freezing. Partial circulation is also particularly advantageous here, for instance via a controllable metering valve, such that only a partial flow from the heat reservoir of the process water in the thermally insulated process technology unit circulates in a closed circuit, with transfer of heat via the process water into the electrolysis module. The required circulation flow of recirculated process water is selected at a minimum level and is controlled, for example, by means of appropriate temperature sensors with regard to the outside temperature and the process water temperature. As a result, standstill operation guided by weather conditions is implemented in the electrolysis system.

The system concept of the invention is therefore particularly advantageously reusable in the case of an isolated grid connection and operation of the electrolysis system with an offshore wind turbine, i.e. without a supply connection to the public power grid. During the periods of low wind and insolation in the winter months, it is thus possible that the electrolysis system will be in shutdown operation for days without power supply. In order to reduce the considerable system costs for battery storage devices, which are estimated at about 76 tonnes of battery mass per wind turbine, the insulation concept of the invention is an inexpensive and particularly efficient measure in order to specifically slow down the process of cooling of the electrolysis modules and prevent freezing. This is done using the available heat in the system, and an additional electric heater from the battery system can be dispensed with entirely or the battery system can have correspondingly smaller dimensions than reserve energy.

In one embodiment of the electrolysis system, the process technology unit has a gas separator including the thermal insulation material.

The gas separator is designed within the process technology unit for phase separation of the product gas from the water. The electrolysis module is connected here to the gas separator via the product conduit. In water electrolysis, hydrogen and oxygen are obtained as product gases—initially in a respective phase mixture with water. A respective gas separator is provided in a product conduit on the hydrogen side and the oxygen side of the electrolysis system. The gas separator is advantageously thermally insulated as a component of the process technology unit that guides the process water. The thermally insulating insulation device therefore advantageously includes the gas separator with the thermal insulation material. For example, the insulation material is applied two-dimensionally to the outside of the vessel wall of the gas separator. In particular, the insulation material is mounted on the gas separator over the full area and the full extent, in order to ensure very good thermal insulation for long shutdown operation.

In one embodiment of the electrolysis system, the reactant conduit and the product conduit are ensheathed by the insulation material.

The thermally insulating sheath can be implemented by means of a thermal pipe insulation with a wall thickness of corresponding dimensions, for example in the form of an insulating hose or a self-adhesive insulating hose, which is conducted tightly and flush around the tubular reactant conduit or correspondingly around the product conduit. For an insulating pipe, preferred possible outer pipe diameters are 20 mm to 120 mm, with wall thicknesses of 10 mm to 50 mm.

In one embodiment of the electrolysis system, the process technology unit has a heat exchanger to which the thermal insulation material has been applied.

What is advantageously provided here is large-area and full-area ensheathing of the heat exchanger with the insulation material, such that the heat in the system can be stored and kept ready for as long as possible. In normal operation, the heat exchanger cools the process water heated and recycled in the electrolysis process. The heat exchanger therefore forms a usable heat reservoir, even in shutdown operation of the electrolysis system, provided that the container is correspondingly thermally insulated. This can be achieved, for example, by a number of correspondingly designed thick-walled plates made of the insulation material, which may be self-adhesive.

In one embodiment of the electrolysis system, the thermal insulation material has a thermal conductivity of less than 0.07 W/m·K, in particular less than 0.04 W/m·K.

The smaller the thermal conductivity chosen, the lower the wall thickness of the insulation material installed in the thermal insulation device can be. Therefore, a thermally highly insulating material having a thermal conductivity of less than 0.04 W/m·K is particularly advantageous. In general, therefore, a minimum thermal conductivity is preferable, such that lower material use is then recorded for the thermal insulation material, and better ease of handling in the construction of the insulation device within the process technology unit.

In one embodiment, the insulation device has an insulation material made of a flexible thermally insulating insulation material.

Mechanical flexibility of the insulation material facilitates easy installation and attachment and adaptation to the geometry of the surface of a component to be thermally insulated in the process technology unit.

Therefore, insulation layer thicknesses or material thicknesses of 9 mm to 30 mm, in particular of 25 mm, are particularly advantageous for the insulation material from the viewpoint of mechanical flexibility and assembly.

In one embodiment, the thermal insulation material includes or consists of an elastomer foam based on synthetic rubber. This choice of material provides particularly effective insulation of the process technology of the electrolysis system, in particular thermal insulation and protection of pipelines, vessels including pipe bends, for storage of the heat energy for shutdown operation. In particular, this saves battery energy which otherwise has to be kept ready for electric heating and maintenance of temperature for frost protection.

Insulating hoses made of the insulation material with self-adhesive closure are advantageously possible, which completely enclose and thermally insulate the pipelines, for example the reactant conduit and the product conduit. The dimensions of the hoses may be such that they are preferably usable for outer pipe diameters of 10-90 mm.

In one embodiment of the electrolysis system, the thermally insulating insulation device is electively designed as a hose, a self-adhesive hose, a plate, a self-adhesive plate, a tape or pipe carrier or combinations thereof.

A use of an electrolysis system of the invention arises in a shutdown operation in which reliable protection against freeze damage is achieved even in the event of an acute risk of frost.

Another use of such an electrolysis system arises in an electrical connection to an offshore wind turbine for power supply, in particular in isolated grid operation, wherein the electrolysis current is drawn from the wind turbine and fed to the electrolysis system.

In the case of this use, an auxiliary energy source used can be a battery storage device, by means of which additional heat is generated in shutdown operation as required, so as to maintain a minimum temperature of the process water.

An auxiliary energy source is only necessary as required and merely in addition to the thermal heat reservoir which is provided and utilizable by virtue of the thermally isolated process technology.

Advantages of the electrolysis system should be regarded as advantageous embodiments of the use of the invention, and vice versa.

### BRIEF DESCRIPTION OF THE DRAWINGS

Further advantages, features and details of the invention will be apparent from the description of the preferred working examples that follows, and from the drawing. The features and combinations of features cited above in the description and the features and combinations of features cited below in the description of the figures and/or shown on their own in the sole figures are usable not just in the respectively specified combination but also in other combinations or on their own, without departing from the scope of the invention.

Working examples of the invention are elucidated in detail by a drawing. These show, in schematic and highly simplified form:

FIG. 1 a schematic diagram of essential components of an electrolysis system for hydrogen production;

FIG. 2 a detail from an electrolysis system with a process technology unit and a circuit on the oxygen side;

FIG. 3 a qualitative representation of a cooling curve of an electrolysis module in shutdown operation of the electrolysis system.

Identical reference symbols have the same meaning in the figures.

### DETAILED DESCRIPTION

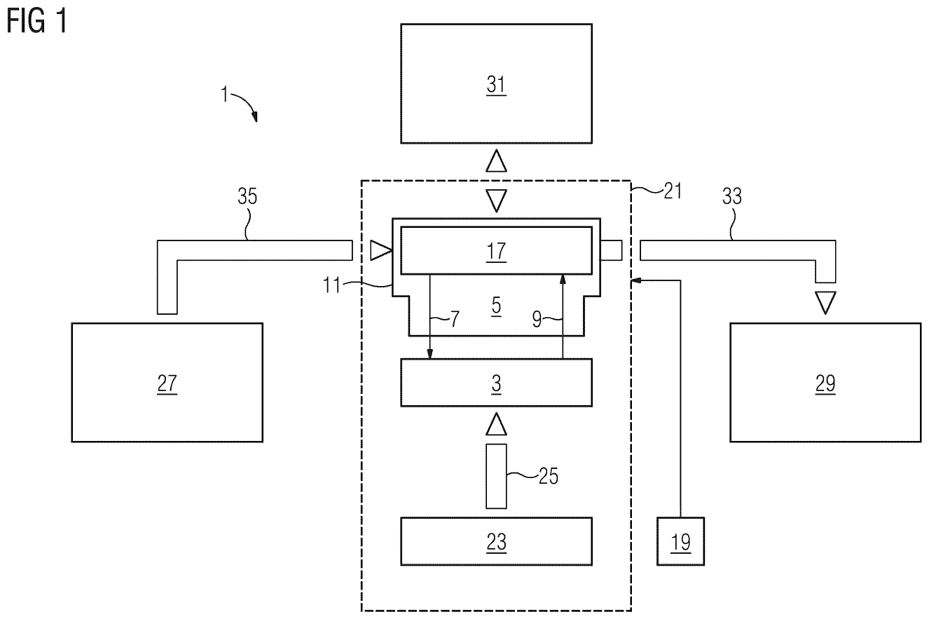

FIG. 1 shows, in a schematic or functional diagram, an electrolysis system 1 for the electrochemical breakdown of water into the product gases hydrogen and oxygen. The electrolysis system 1 is, by way of example, a PEM electrolysis system based on a proton exchange membrane. FIG. 1 shows the typical and essential plant components of a hydrogen production plant based on PEM electrolysis. In addition to the electrolysis unit 21 as the main component for the actual electrolysis process, auxiliary systems such as a water treatment unit 27, a gas cleaning unit 29 and a cooling device 31 are provided for the operation of the electrolysis system 1. The water treatment unit 27 can feed purified and demineralized water as reactant to the electrolysis unit 21 via a supply conduit 35, and it can be metered in as required depending on the process regime and water demand. Product gas obtained from the electrolysis process, for example hydrogen, can be fed in via a product gas conduit 33 to a downstream gas cleaning unit 29. The gas cleaning unit 29 may have several cleaning stages—not shown in detail—and so highly pure hydrogen freed from extrinsic gas components such as oxygen and other impurities is obtained as product gas. There is typically a gas cleaning operation based on catalytic recombination in the gas purification unit 29, since a catalytic cleaning principle has a particularly high cleaning efficiency and specificity, especially with regard to oxygen as extrinsic gas component in the hydrogen product gas. In a compression unit downstream of the gas cleaning unit 29—not shown in FIG. 1—-the hydrogen product gas can be compressed and then stored or transported further.

In the electrolysis unit 21, the actual process of conversion of matter takes place in operation. The electrolysis unit 21 has an electrolysis module 3, a power supply unit 23 and a process technology unit 5. An electrolysis module 3 comprises several electrolysis cells. Several electrolysis modules 3 may be electrically connected in series to form a module cluster or “electrolysis stack” or the actual electrolyzer as the reactor for the electrochemical breakdown of water. In an electrolyzer, the individual electrolysis cells are typically stacked to form an electrolysis module 3 comprising a multitude of individual cells in an axial direction and are assembled to form a module or electrolysis module 3. An electrolyzer typically includes a multitude of electrolysis modules 3, which collectively form what is called an electrolysis stack or simply “stack”. For example, 50 electrolysis cells may be stacked axially to form a module and in turn, for example, 5 electrolysis modules 3 may be stacked in axial direction to form a stack, and so such an electrolysis stack may comprise, for example, 250 cells in an axial overall composite.

As soon as the electrolysis modules 3 or the electrolysis cells or the electrolysis stack have been filled with water for the first time in a PEM electrolyzer, for example after production, it has to be ensured that water (reactant water) or a water-gas mixture always remains in the modules during operation of the electrolyzer. For instance, running-dry or drying-out has to be prevented in every phase of operation, since this would lead to irreversible damage to the electrolyzer. The membrane in particular must always be kept in a moist environment, but other functional parts and components such as the catalyst or the electrodes must not dry out either. In addition, there is also the risk of frost damage as a result of freezing of the process water and irreversible damage to the cells, especially the membrane, in the event of a prolonged interruption or failure of the power supply for the electrolysis current via the power supply unit 23. In remote locations of the electrolysis system 1 or in the case of isolated grid operation independent of the grid, in the case of coupling to a wind turbine, there is a risk of a prolonged power outage in a period of low winds and insolation, particularly in the cold winter months.

In order to counter the risk of freezing and irreversible damage to the cells and the membrane and to maintain prolonged shutdown operation of the electrolysis system 1, the process technology unit 5 is equipped with a thermally insulating insulation device 11. The insulation device 11 comprises a thermal insulation material 17 having low thermal conductivity, for example not more than 0.04 W/m·K, such that a good insulation effect is brought about and cooling is slowed down under shutdown. The process technology unit 5 has a reactant conduit 7 and a product conduit 9, which are each connected to the electrolysis module 3 and in this case—alongside other components of the process technology unit 5—are particularly protected from frost by the insulation device 11. For this purpose, the insulation material 17 is applied to the outer surface of the reactant conduit 7 and the product conduit 9 respectively, for instance over the full extent as tubular pipe insulation. The insulation material 17 has a flexible thermally insulating insulation material, for instance based on an elastomer foam based on synthetic rubber.

By virtue of the process technology unit 5 equipped with the thermally insulating insulation device 11, the heat energy of the water available in the electrolysis system 1 of about 60 ° C., for example, is advantageously still utilizable in shutdown operation in that this heat is kept in the process water circuit for as long as possible and the process water is not left to rapidly cool naturally. A connection to the electrolysis module 3 is provided via the reactant conduit 7 and the product conduit 9, such that the still-warm process water from the process technology unit 5 is transferable into the electrolysis module 3 and is circulatable as required in a circuit via an electrically driven and controlled circulation pump. In this way, the cooling process can be distinctly slowed down without having to significantly resort to electrical auxiliary systems such as the battery storage device 19 for keeping the temperature above the freezing point of water. Because of the use of the heat energy in the system of the process technology unit 5, the dimensions of the battery storage device 19 may therefore be smaller for the shutdown management of the electrolysis system 1. Electrical energy is then taken merely as required from this additional auxiliary energy source, in particular the battery storage device 19, and is advantageously used for operation of the circulation pump in shutdown operation. If necessary, electrically generated heat energy can also be provided additionally in the process water circuit by means of a heating element (e.g. resistance heating) not shown in detail in FIG. 1, in order to heat the process water or to ensure that the temperature is maintained at a minimum temperature for reliable frost protection of the electrolysis modules 3.

In particular, for example, electrical consumers in the process technology unit 5, such as pumps, drives or actuators that generate heat in operation, and likewise fittings and flanges, do not have the insulating layer in order to avoid heat buildup and overheating in these heat-producing components in normal operation and to ensure natural cooling of these components by release of heat. For fittings and flanges, moreover, access is possible if the thermal insulation material 17 is not applied thereto. The thermally insulating insulation device 11 therefore preferably does not comprise these components in order to avoid overheating in operation.

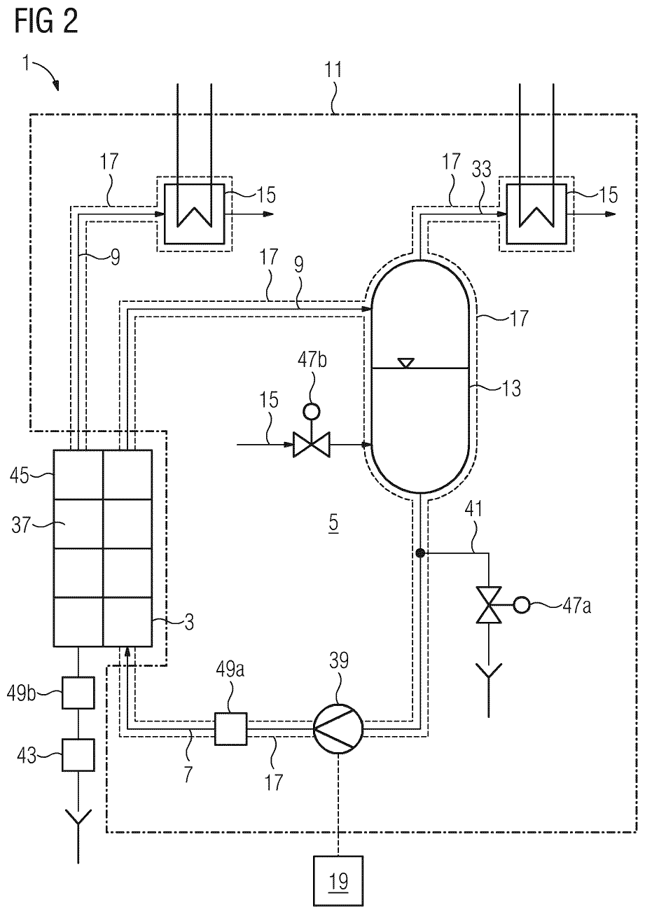

FIG. 2 shows, in a simplified diagram, a detail from an electrolysis system 1 with process technology unit 5 and a circuit on the oxygen side. The electrolysis system 1 is designed for the electrolysis of water, and so hydrogen and oxygen are producible as product gases in operation. The electrolysis system 1 shown here shows an example of just one circuit on the oxygen side. However, it is possible that the process technology unit 5 is designed for a corresponding second circuit on the hydrogen side in a largely analogous manner. FIG. 1 is therefore a simple working example of an electrolysis system 1 in order to illustrate the principle of the heat retention concept of the invention and the utilization of heat in shutdown operation. The electrolysis system 1 has an electrolyzer 45 and electrolysis cell stack 37 having a multitude of electrolysis cells stacked in axial direction, which are not shown in detail. An anodic half-cell and the cathodic half-cell of an electrolysis cell are separated here from a membrane that is not shown in detail. The membrane material comprises PFSA—“perfluorosulfonic acid”—and so the electrolyzer 45 is implemented as a PEM system. Multiple electrolysis cells are stacked and installed in an electrolysis module 3. Multiple electrolysis modules 3 are interconnected to form an electrolysis stack or simply “stack”, which form the actual electrolyzer 45 or reactor for the electrochemical conversion process in the electrolysis system 1.

With this simple circuit, the electrolysis cell stack 37 is supplied with water for the electrolysis reaction, and the water simultaneously also serves to cool the cells during operation. Oxygen produced as the product gas of the electrolysis, together with excess water, is fed into the gas separator 13 for oxygen in a phase mixture. A phase separation takes place in the gas separator 13 and the gaseous oxygen is separated from the liquid water and removed from the circuit via the product gas conduit 33 for the oxygen. In order to maintain the circulation of water in the circuit, the circulation pump 39 is provided in the circuit, and this can be driven if necessary—if the power supply is interrupted—in a shutdown operation with the aid of the battery 19. Used water is compensated for in operation by replenishing demineralized water (DM water) via a magnetic valve 47b via the supply conduit 35. Although the water is demineralized, any minor impurities may accumulate in the circuit. In order to counter this effect, a further magnetic valve 47a can be temporarily opened as required and some of the water can be discarded from the circuit via the drain conduit 41.

There is no circuit on the hydrogen side of the electrolysis system 1 in the working example of FIG. 1. The hydrogen produced is merely discharged via the product conduit 9 for the product gas and is available for further use, for example for subsequent compression. Typically, a pressure relief valve is disposed in the product conduit 9 for the hydrogen product gas, which however is not shown in detail in the working example. This serves to discharge the hydrogen at a certain gauge pressure, which is very desirable in most applications for further processing of the hydrogen. Since liquid water is generally produced on the hydrogen side in PEM electrolysis, a condensate conduit 43 is also provided, which opens when a certain amount of water has accumulated in order to drain off this water. This can be done, for example, with a float. FIG. 1 indicates that this water is discarded. However, it is also possible that this water is likewise used further for electrolysis in that it is returned to the circuit on the oxygen side. This recycling into the process is generally an approach pursued in an economically viable manner for large electrolysis systems 1.

In addition, a sensor 49a and a sensor 49b are incorporated in the electrolysis system 1, which serves for in situ monitoring of the quality of the process water in the system. The sensors 49a, 49b can each be designed and incorporated as a conductivity sensor for measuring specific conductivity as a quality indicator. These conductivity sensors 5a, 5b can be used, for example, to conclude the fluoride concentrations in the water via a particular correlation. It is particularly advantageous here to incorporate the conductivity sensors 5a, 5b at points with maximum system pressure, since a degassing of dissolved hydrogen or oxygen is particularly low or unlikely here. Gas bubbles would interfere with precise measurement of conductivity and distort the result. Therefore, the conductivity sensors are positioned at a geodetically low point in the electrolysis system 1 in order to exploit hydrostatic pressure advantages and hence effectively counteract degassing.

The process technology unit 5 is provided with a thermal insulation device 11 having a thermal insulation material 17 applied to surfaces of components of the process technology unit 5. The insulation material 17 comprises a material with minimum thermal conductivity of not more than 0.04 W/m·K, for example, a material under the Armaflex or Armaflex Ultima trade name can be used in the design and configuration of the thermal insulation device 11. An elastomer foam based on synthetic rubber is particularly suitable for this purpose, in order to also enable mechanical flexibility in the installation and heat-sealing mounting of the insulation material 17 on the surface of selected plant components and component parts in the process technology unit 5. For thermal insulation of the process technology unit 5, at least the components that carry or contain process heat during operation are thermally insulated with the insulation material. Thus, the gas separator 13 is very substantially ensheathed with the insulation material 17, and the reactant conduit 7 and the product conduit 9 with corresponding tubular insulation hoses, which comprise the insulation material in a corresponding wall thickness. The heat exchangers 15 in the respective product gas conduit 33 that are present, for instance, in the process technology unit 5 are also thermally insulated and tightly ensheathed with the insulation material 17. The heat exchangers 15 ensure that the product gas obtained-hydrogen or oxygen-is cooled down in operation, such that the heat exchange medium, i.e. the water, is correspondingly heated to a higher temperature by absorbing heat. This heat content is additionally utilizable in a shutdown operation of the electrolysis system 1 in order to delay cooling of the electrolysis module 3 and to safely prevent freezing of process water in the electrolysis module 3.

Especially in isolated grid operation, the heat retention concept is very economical and reliable for frost protection of the electrolysis system 1 over several days. Electrical connection of the electrolysis system 1 and supply of electrical power and power supply to the power supply unit 23—in accordance with the observations in FIG. 1—is effected in that case, for example, via an offshore wind turbine in an isolated grid, autonomously from a grid connection. The electrolysis current from the wind turbine is fed here to the electrolysis system 1 and, after appropriate rectification, fed to an electrolysis module 3 via the connection wire 25 (see FIG. 1). An auxiliary energy source used is a battery storage device 19, by means of which additional heat is generated in shutdown operation as required, so as to always maintain a minimum temperature of the process water. However, the heat management concept in the present context means that the auxiliary and storage systems can be of much smaller dimensions and therefore less costly.

The battery 19 may generally be used for an emergency power supply (UPS), for example to span a brief power outage. In isolated grid operation, the battery 19 is additionally required to prevent freezing if necessary in the case of a possible emergency, but with a distinctly lower battery capacity for an emergency heating requirement to be kept ready. Keeping the temperature above the freezing point and hence providing reliable frost protection in shutdown operation is achieved primarily via utilization of the intrinsic heat energy in the process water.

Even in summer, the battery 19 can be used as required and advantageously for cooling. In midsummer and with a typical process water temperature of 60 ° C. in the water circuit, overheating protection can hereby also be achieved in association with the insulation device 11, for example by dissipating excess heat via the cooling device 31 (see FIG. 1). In principle, a container solution is another possible configuration of the thermally insulating insulation device 11, with a thermally insulated container with on-demand cooling such that the process technology unit 5 and/or the electrolysis unit 21 do not overheat in summer when they are set up within an insulation vessel such as a container. Because of the insulating effect of an insulation device 11 in the form of a container, the required cooling capacity would also be reduced in summer.

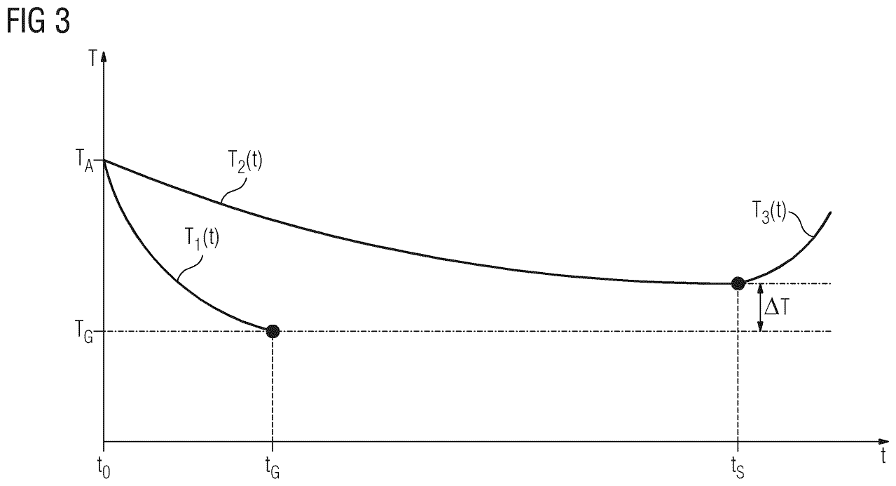

FIG. 3 shows a qualitative representation, in a diagram, of a cooling curve of an electrolysis module 3 in shutdown operation of the electrolysis system 1. The electrolysis system 1 is supplied with power from an offshore wind turbine in autonomous isolated grid operation, for instance on an offshore platform at sea. At time t=0, a period of low wind and insolation begins for a relatively long period of time in the winter months, and so the power supply for the electrolysis is interrupted for a correspondingly long time and there is an acute risk of frost. Time t is plotted on the x axis of the diagram according to FIG. 3, and the temperature T of the water in an electrolysis module 3 is plotted on the y axis against time. At the start t=0 of shutdown operation, the temperature in the process water is, for example, T_{A}=60 ° C.

In a conventionally designed electrolysis system 1, the cooling process takes place in a short time according to the temperature progression over time T₁(t) and, in spite of auxiliary systems via additional heating by electricity from the battery 19, freezing at the freezing temperature T_{G}=0 ° C., and hence irreversible damage to the electrolysis cells 37 of a module 3, is avoidable only for a maximum of a few hours. In the case of prolonged periods of low wind and insulation, therefore, owing to limited battery capacity under frost conditions, freezing of the water will set in after a comparatively short time to in shutdown operation in spite of the additional heating via auxiliary systems.

In contrast, the temperature progression over time, T₂(t), shows the advantages that arise from the heat storage and heat utilization concept of the invention: By virtue of the process technology unit 5 equipped with the thermally insulating insulation device 11, the heat energy available directly from operation in the electrolysis system 1 is advantageously still utilizable even in shutdown operation in that it is kept in the process water circuit for as long as possible and the process water is not left to rapidly cool naturally as before. The thermal insulation material 17 of the insulation device 11 provides an effective passive insulation measure in order to keep the available heat energy ready in the system and to use it for as long as possible. As a result, in a shutdown operation, significantly slowed cooling of the process water is achieved and freezing damage in an electrolysis module 3 is safely avoided, and for a prolonged period of time. As a result, the temperature progression over time, T₂(t), can be reliably kept around a value ΔT above the freezing temperature T_{G}=0 ° C. of water in a virtually asymptotic manner—it is merely as an alternative that additional heat can be introduced via the battery 19 if additional heat is required, for example via a resistance heater. In principle, the heat-carrying process water at about 60 ° C. is available for this purpose initially, i.e. at t=0, via the reactant conduit 7 as inlet conduit and the product conduit 9 as return conduit, and also in the other containers of the process technology unit 5, as heat reservoir and heating medium. Because of the specific thermal isolation of the process technology unit 5 with an insulation material 17, the cooling process can therefore be significantly slowed down compared to the known measures, particularly under frost conditions, for at least several days and advantageously even beyond that. This means that even longer periods of low wind and insulation in isolated offshore operation can be spanned without risk of frost damage. A battery 19 or other storage system may still be provided in the electrolysis system 1. However, this may have distinctly smaller dimensions because of intrinsic temperature maintenance by the thermally insulating insulation device 11 of the process technology unit 5, and is also available as required for purposes other than heating purposes, for instance for operating a circulation pump 39 that is preferably present for the process water as heating medium in the reactant conduit 7 or the product conduit 9. Maintenance of temperature can thus be enabled and maintained over several days by a circulation process, and cooling can be slowed, with reliable prevention of freezing. Partial circulation is also particularly advantageous here, for instance via a controllable metering valve, such that only a partial flow from the heat reservoir of the process water within the thermally insulated process technology unit 5 circulates in a closed circuit, with transfer of heat via the process water as heat transfer medium in a controlled manner into the electrolysis module 3. The water therefore remains liquid and the sensitive membrane remains soaked with water or is kept moist. As soon as the period of low wind and insolation ends after a period of time and the power supply can be resumed, shutdown operation is ended from a time tₛ and the electrolysis system 1 is restarted and put into normal operation, such that the temperature progression over time, T₃(t), of the process water shows a rising curve until a normal operating temperature at about T_{A}=60 ° C. is attained again.

1. An electrolysis system for production of hydrogen and oxygen as product gases, comprising:
an electrolysis module; and
a process technology unit,
wherein the process technology unit has a reactant conduit for process water supply and a product conduit that are each connected to the electrolysis module,
wherein the process technology unit is equipped with a thermally insulating insulation device comprising a thermal insulation material so as to accomplish slowed cooling of the process water in shutdown operation.

2. The electrolysis system as claimed in claim 1, wherein the process technology unit has a gas separator including the thermal insulation material.

3. The electrolysis system as claimed in claim 1, wherein the reactant conduit and the product conduit are ensheathed by the insulation material.

4. The electrolysis system as claimed in claim 1, wherein the process technology unit has a heat exchanger to which the thermal insulation material has been applied.

5. The electrolysis system as claimed in claim 1, wherein the thermal insulation material has a thermal conductivity of less than 0.07 W/m·K, in particular less than 0.04 W/m.K.

6. The electrolysis system as claimed in claim 1, wherein the insulation device has an insulation material made of a flexible thermally insulating insulation material.

7. The electrolysis system as claimed in claim 6, wherein the insulation material comprises an elastomer foam based on synthetic rubber.

8. The electrolysis system as claimed in claim 1, wherein the thermally insulating insulation device is electively designed as a hose, self-adhesive hose, sheet, self-adhesive sheet, tape or tube carrier, or combinations thereof.

9. The use of an electrolysis system as claimed in claim 1, on an electrical connection to an offshore wind turbine for power supply, in particular in isolated grid operation, wherein the electrolysis current is drawn from the wind turbine and fed to the electrolysis system.

10. The use as claimed in claim 8, in which an auxiliary energy source used is a battery storage device, by means of which additional heat is generated in shutdown operation as required, so as to maintain a minimum temperature of the process water.
